(19) United States
(12) Patent Application Publication
(10) Pub. No.: US 2009/0229578 A1
(43) Pub. Date: Sep. 17, 2009

(54) CONTROL DEVICE ENABLING INTEGRATED OPERATION OF VEHICLE ELECTRIC SYSTEM AND ENGINE ELECTRIC SOLENOID FUEL INJECTION AND IGNITION SYSTEMS

(76) Inventor: Ming Hui LIN, Taipei County (TW)

Correspondence Address: RABIN & Berdo, PC, 1101 14TH STREET, NW, SUITE 500, WASHINGTON, DC, 20005, US

(21) Appl. No.: 12/048,915

(22) Filed: Mar. 14, 2008

(51) Int. Cl. F02M 51/00

(52) U.S. Cl. 123/476; 123/478

(57) ABSTRACT

A control device enabling integrated operation of vehicle electric system and engine electric solenoid fuel injection and ignition systems includes a timing circuit for driving a pulse generator to generate a pulse signal. The pulse generated by the pulse generator is limited and then phase-shifted and amplified. The pulse signal for switching operation is then loaded into a positive terminal of a power supply on a motor vehicle by another power device. The control device may further include an automatic distinguishing unit for setting the control device to start and stop working at preset voltages. The transient pulse generated by the control device at engine start enables the spark plug to be instantaneously ignited, and may be stably maintained at a constant transient voltage value to stably supply transient voltage and current to the spark plug and the fuel injector needle valve of the motor vehicle fuel injection system.

### FIELD OF THE INVENTION

The present invention relates to a control device enabling integrated operation of vehicle electric system and engine electric solenoid fuel injection and ignition systems, and more particularly to an electronic device for improving the engine ignition and combustion condition on a motor vehicle through integrated operation of the vehicle electric system and the fuel injection and ignition systems, so that the motor vehicle may have enhanced engine transient explosion pressure and achieve the effects of saving fuel and reducing exhaust emission.

### BACKGROUND OF THE INVENTION

The current engine design and production for motor vehicles, such as cars and motorcycles, has reached a quite matured stage. However, due to different using and driving conditions, not all the current motor vehicle engines can optimally extend the designed performance thereof.

For current vehicles equipped with the fuel injection system, fuel is supplied via the fuel pump to the injection valves. Each of the injection valves is controlled by a small-scale electric solenoid, which is connected to the battery via a vehicular electronic control unit (ECU) for rearward pulling the fuel injector needle valve through related controls, so that fuel is injected from the valve. The aforesaid vehicular ECU causes the valve to open for a period of time that varies with different driving conditions. For example, when the accelerator of the vehicle is stepped on, the vehicular ECU will cooperate with other related electronic devices to open the valve for a longer period of time in order to supply sufficient fuel to the engine. However, since the output current and voltage of the battery, the ECU, and the fuel injection system on each vehicle are set to predetermined values in the manufacturer's plant before the vehicle is delivered, the fuel injector needle valve can only be actuated with the preset systems and units.

Meanwhile, taking the spark plug central electrode in the ignition system of the motor vehicle as an example, when the supply voltage is insufficiently delivered to the spark plug, the transient voltage and transient current produced by the spark plug will not be enough for extended spark duration. As a result, it is uneasy to ignite the fuel air mixture with low fuel-air ratio and provide finely atomized fuel to the fuel injector. This condition will indirectly results in incomplete combustion in the engine cylinders.

When the electric system and the engine electric solenoid fuel injection and ignition systems of the motor vehicle fail to closely cooperate with one another, problems such as difficult engine starting, insufficient engine power, lowered acceleration performance, and fouled spark plug would occur. Also, when the fuel is supplied while the electric system and the engine ignition system of the motor vehicle are not in an optimally matched condition, problems such as high fuel consumption and excessive accumulation of fuel supply will occur to result in further deterioration of motor vehicle performance, insufficient torsion force, significantly lowered force per unit time, and aging of vehicle.

The unmatched vehicle electric system and engine solenoid fuel injection and ignition systems not only have adverse influences on the motor vehicle performance, but also increase the vehicle exhaust emission to result in high air pollution index, making the motor vehicles one of the largest sources of ecological environment pollution.

### SUMMARY OF THE INVENTION

It is therefore a primary object of the present invention to provide a control device enabling integrated operation of vehicle electric system and engine electric solenoid fuel injection and ignition systems, so that a motor vehicle may have effectively enhanced battery discharge per unit time, upgraded combustion efficiency in engine cylinders, lowered fuel consumption, and reduced exhaust emission.

Another object of the present invention is to provide a control device enabling integrated operation of vehicle electric system and engine electric solenoid fuel injection and ignition systems, so that a motor vehicle may have increased torsion force and force per unit time to enable faster and smoother engine starting as well as upgraded acceleration performance and climbing power.

A further object of the present invention is to provide a control device enabling integrated operation of vehicle electric system and engine electric solenoid fuel injection and ignition systems, so that a motor vehicle may have stably operated electric system and the problems of unstable rotating speed, unsmooth power window operation, and poor air-conditioning performance caused by the aging of vehicle electric system can be improved.

A still further object of the present invention is to provide a control device enabling integrated operation of vehicle electric system and engine electric solenoid fuel injection and ignition systems, so that peripheral electronic apparatus provided on a motor vehicle may stably operate and have enhanced interference prevention ability.

To achieve the above and other objects, the control device enabling integrated operation of vehicle electric system and engine electric solenoid fuel injection and ignition systems according to the present invention at least includes a timing circuit for driving a pulse generator to generate a pulse signal. Then, the pulse signal for switching operation is loaded into a positive terminal of a power supply on a motor vehicle by another power device.

In a preferred embodiment, the pulse generator is an integrated circuit (IC).

In an operable embodiment, the pulse generator generates transient pulse within the range from 8 KHz to 50 KHz.

In a preferred embodiment, the control device further includes an automatic distinguishing unit for setting the control device to start working and stop working at preset voltages.

In an operable embodiment, the automatic distinguishing unit includes a voltage-divider circuit, which divides the battery voltage of the motor vehicle and applies the divided voltage to a negative terminal of a reference diode. The reference diode is selectively broken down depending on the preset voltages. The automatic distinguishing unit also includes a switch device that cooperates with a relay having a normal open contact to control whether the pulse signal is applied from the positive terminal of the motor vehicle power supply to the spark plug of the motor vehicle engine and the fuel injector needle valve.

In a preferred embodiment, the control device is set to start working when a car motor has a voltage higher than 12.4V, and to stop working when the car motor has a voltage lower than 12.2V.

In another operable embodiment, the control device further includes a reverse connection protection.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a preferred circuit diagram for the control device enabling integrated operation of vehicle electric system and engine electric solenoid fuel injection and ignition systems according to the present invention.

### DETAILED DESCRIPTION OF THE PREFERRED EMBODIMENTS

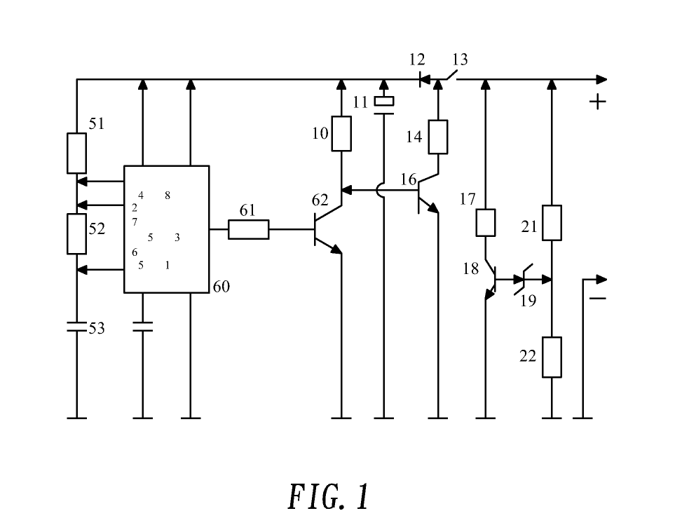

Please refer to FIG. 1 that is a preferred circuit diagram for a control device enabling integrated operation of vehicle electric system and engine electric solenoid fuel injection and ignition systems according to the present invention. As shown, the control device of the present invention includes an RC timing circuit consisting of two resistors 51, 52 and a capacitor 53 for driving a pulse generator 60 to generate a rectangular signal via the third pin thereof.

In a preferred embodiment of the present invention, the pulse generator 60 is an integrated circuit (IC) to preferably generate transient pulse within the range from 8 KHz to 50 KHz.

The pulse generated by the pulse generator 60 is limited by a resistor 61, and the pulse signal is then phase-shifted and amplified by a triode 62 and a cooperating resistor 10. The pulse signal for switching operation is then loaded into a positive terminal of a motor vehicle power supply through another power triode 16 and a cooperating resistor 14, as shown in FIG. 1.

In a preferred embodiment, the control device of the present invention further includes an automatic distinguishing unit for setting the control device to automatically start working when the motor vehicle, such as a car, has a voltage higher than 12.4V, and to automatically stop working when the engine of the motor vehicle stops or the battery of the motor vehicle or car has a voltage lower than 12.2V. In this manner, the motor vehicle is able to always maintain a power supply needed by it to start the engine, and avoid from consuming the current of the motor vehicle battery.

In the illustrated embodiment, the automatic distinguishing unit includes a voltage-divider circuit consisting of two resistors 21, 22. The resistors 21, 22 divide the battery voltage of the motor vehicle and apply the divided voltage to a negative terminal of a reference diode or Zener diode 19. In the case of a car, when the car motor has a voltage higher than 12.4V, the reference diode 19 is broken down, which brings a triode 18 to turn on and a relay 17 to close, so that a normal open contact 13 of the relay 17 is closed, and the whole circuit of the control device is made to start working, and the above-mentioned pulse signal is applied from the positive terminal of the vehicle power supply to a spark plug of the engine and the fuel injector needle valve.

When the engine stops and the vehicle battery has a voltage lower than 12.2V, the voltage-divider circuit consisting of the resistors 21, 22 fails to break down the reference diode 19, so that the triode 18 is turned off and the relay 17 is opened to bring the contact 13 to open, and the whole system is interrupted and stops working.

In a preferred embodiment, the control device of the present invention further includes a reverse connection protection, which may include a diode 12 cooperating with the resistor 10 and a filter capacitor 11. In the event the control device of the present invention is connected to the vehicle battery with incorrect polarity connection, the reverse connection protection will cause the control device of the present invention to stop working, so as to protect the whole motor vehicle electric system against damage.

When the control device of the present invention is applied to a car, the positive and negative terminals of the control device are parallelly connected to the positive and negative terminals of the car battery, respectively. When the car is started and the car motor has an output voltage higher than or equal to 12.4V, the control device of the present invention will be started to work and generates transient pulse of 8 KHz to 50 KHz, so that the spark plug of the car is instantaneously ignited and the car enters into an operating state. The transient pulse generated by the control device may be stably maintained at a constant transient voltage value. Within a safety working voltage range set for the originally designed car electric system, the transient pulse may stably supply transient voltage and current to the central electrode of the vehicle sparkplug, so that the sparkplug central electrode produces higher voltage and temperature and the car battery discharges at a faster speed to supply a larger current to the electric solenoid fuel injection system. The higher temperature produced by the spark plug central electrode works to burn off the carbon deposited on the spark plug and thereby prevents ash residue from forming on the spark plug. Intensive transient voltage and current enables not only extended spark duration to ignite fuel air mixture with low fuel-air ratio, but also the supply of finely atomized fuel to the fuel injector. Meanwhile, the fuel injector needle valve can also operate correspondingly. Therefore, the car engine can operate in a fuel-saving manner with reduced exhaust emission.

With the above arrangements, the control device of the present invention provides the following advantages: (1) it effectively enhances the vehicle battery discharge per unit time, upgrades combustion efficiency in engine cylinders, lowers fuel consumption, and reduces exhaust emission; (2) it enables a motor vehicle to have increased torsion force and force per unit time and accordingly, faster and smoother engine starting as well as upgraded acceleration performance and climbing power; (3) it stabilizes vehicle electric system operations and improves the problems of unstable rotating speed, unsmooth power window operation, and poor air-conditioning performance caused by the aging of vehicle electric system; and (4) it enables peripheral electronic apparatus provided on the motor vehicle to work stably and have enhanced interference prevention ability.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A control device enabling integrated operation of vehicle electric system and engine electric solenoid fuel injection and ignition systems, comprising a timing circuit for driving a pulse generator to generate a pulse signal; the pulse generated by the pulse generator being limited and then phase-shifted and amplified; and the pulse signal for switching operation being then loaded into a positive terminal of a power supply on a motor vehicle by another power device.

2. The control device as claimed in claim 1, wherein the pulse generator is an integrated circuit (IC).

3. The control device as claimed in claim 1, wherein the pulse generator generates transient pulse within the range from 8 KHz to 50 KHz.

4. The control device as claimed in claim 2, wherein the pulse generator generates transient pulse within the range from 8 KHz to 50 KHz.

5. The control device as claimed in claim 1, further comprising an automatic distinguishing unit for setting the control device to start working and stop working at preset voltages.

6. The control device as claimed in claim 5, wherein the automatic distinguishing unit includes a voltage-divider circuit for dividing a battery voltage of the motor vehicle and applying the divided voltage to a negative terminal of a reference diode, which is selectively broken down depending on the preset voltages, and a switch device that cooperates with a relay having a normal open contact to control whether the pulse signal is applied from the positive terminal of the motor vehicle power supply to a spark plug of an engine and a fuel injector needle valve of the motor vehicle.

7. The control device as claimed in claim 6, wherein the preset voltage for the control device to start working is a vehicle motor voltage higher than 12.4V, and the preset voltage for the control device to stop working is a vehicle motor voltage lower than 12.2V.

8. The control device as claimed in claim 1, further comprising a reverse connection protection.
